(19) United States
(12) Patent Application Publication
(10) Pub. No.: US 2025/0297385 A1
(43) Pub. Date: Sep. 25, 2025

(54) SURFACE MODIFICATION METHOD OF NICKEL-BASED CATALYTIC MATERIAL FOR WATER ELECTROLYSIS, AND CATALYTIC MATERIAL FOR WATER ELECTROLYSIS

(71) Applicant: University of Science and Technology Beijing, Beijing (CN)

(72) Inventors: Yue ZHANG, Beijing (CN); Zhen TIAN, Beijing (CN); Zhuo KANG, Beijing (CN); Yong XIE, Beijing (CN); Wenhao ZHENG, Beijing (CN); Zhouyu JIANG, Beijing (CN); Anyuan QIU, Beijing (CN); Yu SUN, Beijing (CN); Xin WANG, Beijing (CN)

(73) Assignee: University of Science and Technology Beijing, Beijing (CN)

(21) Appl. No.: 19/073,083

(22) Filed: Mar. 7, 2025

(30) Foreign Application Priority Data
Mar. 20, 2024 (CN) 202410316319.9

(51) Int. Cl. C25B 11/046; C25B 1/04

(52) U.S. Cl. CPC C25B 11/046; C25B 1/04

(57) ABSTRACT

A surface modification method of a nickel-based catalytic material for water electrolysis, and a catalytic material for water electrolysis are provided. The method includes: immersing a nickel-based substrate material to be modified in a first solution including a transition metal cation to allow a first modification treatment, such that a layered double hydroxide (LDH) is produced on a surface of the nickel-based substrate material; conducting a plasma etching treatment for the LDH produced on the surface of the nickel-based substrate material after the first modification treatment to produce a cation/anion double vacancy-containing LDH; and immersing the cation/anion double vacancy-containing LDH produced after the plasma etching treatment in a second solution including a high-valent metal cation to allow a second modification treatment, such that a high-valent metal single atom-containing LDH is produced. The method has advantages such as simple process, low cost, and high stability.

### CROSS REFERENCE TO THE RELATED APPLICATIONS

This application is based upon and claims priority to Chinese Patent Application No. 202410316319.9, filed on Mar. 20, 2024, the entire contents of which are incorporated herein by reference.

### TECHNICAL FIELD

The present disclosure relates to the technical field of catalysis for water electrolysis, and particularly relates to a surface modification method of a nickel-based catalytic material for water electrolysis, and a catalytic material for water electrolysis.

### BACKGROUND

The water electrolysis for hydrogen production is considered as a clean energy technology for achieving the global carbon neutrality. The water electrolysis for hydrogen production includes an anodic oxygen evolution reaction (OER) and a cathodic hydrogen evolution reaction (HER). Both HER and OER occur at an interface between a material and an electrolyte. The kinetics of OER involves a plurality of proton-coupled electron transfer steps, and is slower than the kinetics of HER, which limits the efficiency of overall water splitting to a large extent.

Currently, nickel-based catalytic materials for water electrolysis are widely used as catalytic materials for commercial alkaline electrolytic cells due to excellent hydrogen and oxygen evolution activities during water electrolysis and impurity resistance. However, due to a small number of active sites on a surface of a nickel-based catalytic material for water electrolysis during a reaction process, a large overpotential is required, which makes the water electrolysis involve large energy consumption and can hardly meet the needs of commercial production. Therefore, how to develop an electrocatalytic material with high activity, low cost, and long-term stable working is still an urgent problem to be solved.

### SUMMARY

In view of this, the embodiments of the present disclosure provide a surface modification method of a nickel-based catalytic material for water electrolysis, and a catalytic material for water electrolysis. The method has advantages such as simple process, low cost, and high stability, and is suitable for commercial electrolytic cells.

In a first aspect, an embodiment of the present disclosure provides a surface modification method of a nickel-based catalytic material for water electrolysis, and adopts the following technical solutions:

The surface modification method of a nickel-based catalytic material for water electrolysis includes:

the nickel-based substrate material to be modified is immersed in a first solution containing transition metal cations for a first modification treatment to form a layered double hydroxide (LDH) on the surface of the nickel-based substrate material;
the LDH formed on the surface of the nickel-based substrate material after the first modification treatment is subjected to plasma etching to form a cation/anion double vacancy LDH; and
the plasma-etching-treated cation/anion double vacancy LDH is immersed into a second solution containing high-valent metal cations for a secondary modification treatment to form an LDH containing single atoms of a high-valent metal.

In a possible embodiment of the first aspect, the transition metal cation in the first solution includes at least one of the following ions: a Fe ion, a Co ion, a Cr ion, a Cu ion, a Zn ion, and a Mn ion.

In a possible embodiment of the first aspect, the first solution further includes urea and ammonium fluoride.

In a possible embodiment of the first aspect, the first solution further includes a surfactant.

In a possible embodiment of the first aspect, the first modification treatment is conducted for 4 h to 8 h at 30° C. to 60° C.

In a possible embodiment of the first aspect, the high-valent metal cation in the second solution includes at least one of the following ionic salts: tungsten hexachloride, sodium molybdate dihydrate, and sodium metavanadate dihydrate.

In a possible embodiment of the first aspect, the high-valent metal cation in the second solution includes a tungsten ion, and the second solution is prepared from tungsten hexachloride, absolute ethanol, and pure water.

In a possible embodiment of the first aspect, the high-valent metal cation in the second solution includes a molybdenum ion, and the second solution is prepared from sodium molybdate dihydrate and deionized water, and a temperature of the deionized water is 2° C. to 8° C.

In a possible embodiment of the first aspect, the high-valent metal cation in the second solution includes a vanadium ion, and the second solution is prepared from sodium metavanadate dihydrate and pure water; and the water bath during the second modification treatment has a temperature of 50° C. to 70° C.

In a second aspect, an embodiment of the present disclosure further provides a catalytic material for water electrolysis, and adopts the following technical solution:

The catalytic material for water electrolysis includes a nickel-based substrate material and a high-valent metal single atom-containing LDH modified on a surface of the nickel-based substrate material, where the catalytic material for water electrolysis is prepared by the surface modification method of a nickel-based catalytic material for water electrolysis described above.

As above, the surface modification method of the nickel-based catalytic material for water electrolysis in the embodiments of the present disclosure is as follows: firstly, the nickel-based substrate material to be modified is immersed into a first solution containing transition metal cations for a first modification treatment to form an LDH on the surface of the nickel-based substrate material; then the LDH formed on the surface of the nickel-based substrate material after the first modification treatment is subjected to a plasma etching treatment to form a cation/anion double vacancy-containing LDH; and then the cation/anion double vacancy-containing LDH formed after the plasma etching treatment is subjected to a second modification treatment in a second solution containing high-valent metal cations to form a high-valent metal monoatomic LDH.

That is, in the embodiment of the present disclosure, a nickel-based composite catalytic material with uniform vacancies of nickel and oxygen atoms can be first prepared controllably through wet chemical impregnation and plasma etching, and then a nickel-based electrode material with a high-valent element single-atom system can be further constructed with the assistance of hydrothermal synthesis. This preparation method involves a simple process and readily available raw materials. In addition, the nickel-based electrode material with a high-valent element single-atom system allows a rapid, efficient and mild reaction and high electrocatalytic oxygen evolution performance, is suitable for large-area production, and has a great potential value and a promising application prospect in water electrolysis. Therefore, the present disclosure provides a research idea for the preparation of electrode materials for efficient and stable alkaline electrolytic cells.

The above description is merely an overview of the technical solutions of the present disclosure. In order to allow the technical means of the present disclosure to be understood clearly and implemented in accordance with the content of the specification and allow the above and other objectives, features, and advantages of the present disclosure to be obviously and easily understood, the present disclosure is described in detail below with reference to the preferred embodiments and accompanying drawings.

### BRIEF DESCRIPTION OF THE DRAWINGS

To describe the technical solutions in the embodiments of the present disclosure clearly, the accompanying drawings required for describing the embodiments are briefly described below. Apparently, the accompanying drawings in the following description show merely some embodiments of the present disclosure, and those of ordinary skill in the art may still derive other drawings from these accompanying drawings without creative efforts.

FIG. 1 shows a flow chart of a surface modification method of a nickel-based catalytic material for water electrolysis provided in an embodiment of the present disclosure;

FIG. 2 shows a functional block diagram of a surface modification method of a nickel-based catalytic material for water electrolysis provided in an embodiment of the present disclosure;

FIG. 3 shows scanning electron microscopy (SEM) images provided in an embodiment of the present disclosure;

FIG. 4 shows electron paramagnetic resonance (EPR) spectroscopy spectra of oxygen vacancies provided in an embodiment of the present disclosure;

FIG. 5 shows EPR spectroscopy spectra of nickel vacancies provided in an embodiment of the present disclosure;

FIG. 6 shows a transmission electron microscopy (TEM) image provided in an embodiment of the present disclosure;

FIG. 7 shows a local enlarged view of transmission electron microscopy and an atom integrated intensity diagram provided in an embodiment of the present disclosure;

FIG. 8 shows an atom integrated intensity plot produced after fast Fourier transform of transmission electron microscopy provided by embodiment of the present disclosure;

FIG. 9 shows performance testing results of electrolytic cells provided in an embodiment of the present disclosure;

FIG. 10 shows performance testing results of a commercial industrial alkaline electrolytic cell provided in an embodiment of the present disclosure.

### DETAILED DESCRIPTION OF THE EMBODIMENTS

The embodiments of the present disclosure will be described in detail below with reference to the accompanying drawings.

It should be clarified that the implementations of the present disclosure are described below through specific embodiments, and those skilled in the art can easily understand other advantages and effects of the present disclosure from the contents disclosed in this specification. Apparently, the described embodiments are merely some rather than all embodiments of the present disclosure. The present disclosure can also be implemented or applied through other different specific implementations. Based on different viewpoints and applications, various modifications or amendments can be made to various details of this specification without departing from the spirit of the present disclosure. It should be noted that the following embodiments and features in the embodiments may be combined with each other provided that no conflict occurs. All other embodiments obtained by a person of ordinary skill in the art based on the embodiments of the present disclosure without creative efforts should fall within the protection scope of the present disclosure.

It should be noted that the various aspects of the embodiments within the scope of the appended claims are described below. Apparently, the aspects described herein may be embodied in a wide variety of forms, and any particular structure and/or function described herein is/are merely illustrative. On the basis of the present disclosure, those skilled in the art should understand that one of the aspects described herein may be implemented independently of any other aspects and two or more of these aspects may be combined in various ways. For example, any number of aspects described herein can be used to implement an apparatus and/or practice a method. In addition, the apparatus may be implemented and/or the method may be practiced with other structures and/or functions other than one or more of the aspects described herein.

It should be noted that, the drawings provided in the following embodiments merely illustrate the basic concepts of the present disclosure schematically. Although the drawings only show components related to the present disclosure rather than be drawn according to the quantities, shapes, and sizes of components in actual implementation, patterns, quantities, and proportions of components in actual implementation may be changed randomly, and the component layout may be complex.

In addition, in the following description, specific details are provided to facilitate the thorough comprehension of examples. However, those skilled in the art will understand that the aspects can be practiced without these specific details.

Long-term and sufficient industrial studies have shown that the improvement of a catalytic activity for hydrogen and oxygen evolution of an electrode material in an electrolytic cell is a very effective means to reduce the energy consumption of water electrolysis. Since both HER and OER occur at an interface between a material and an electrolyte, the increase of an electrochemical surface area of an electrode can provide increased reactive sites, which can improve the catalytic activity and reduce the energy consumption of an electrolytic cell. Therefore, there is an urgent need to develop a nickel electrode material with a low economic cost, a large electrochemical specific surface area, and many active sites to significantly improve the catalytic performance and meet the needs of commercial production.

In view of various problems such as uncontrollable structures, poor stability, and scarce active sites of pure nickel-based substrate materials (nickel plates, nickel meshes, and nickel foams), the inventors propose the following solution: A produced material can be subjected to anion and cation removal by a plasma etching process to allow the uniform defects of both anions and cations, and then a high-valent element can be introduced by a low-temperature wet chemical method to construct a single-atom system. As a result, a surface spatial morphology, a size, and an electronic structure of the material can be well regulated, such that the material has a large electrochemical specific surface area and has increased catalytic active sites exposed, which further improves the electrocatalytic activity.

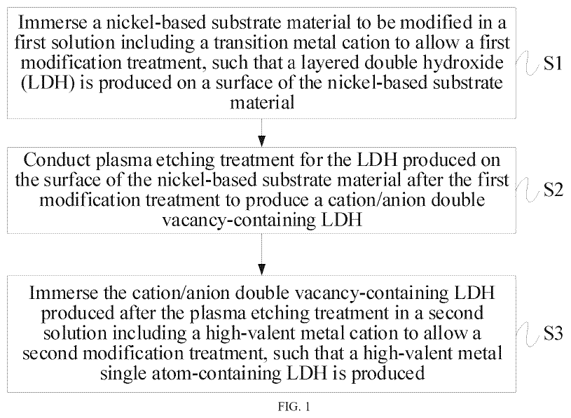

Based on this, an embodiment of the present disclosure provides a surface modification method of a nickel-based catalytic material for water electrolysis. As shown in FIG. 1, the surface modification method of a nickel-based catalytic material for water electrolysis provided in the embodiment of the present disclosure includes S1 to S3:

S1: A nickel-based substrate material to be modified is immersed in a first solution including a transition metal cation to allow a first modification treatment, such that LDH is produced on a surface of the nickel-based substrate material.

LDH is a metal hydroxide including two or more metal elements. LDH is produced through the stacking of positively-charged (M²⁺, M³⁺)(OH)₆ octahedral host layers and interlayer negatively-charged anions and water molecules. Active sites of LDH are mainly active metal ions on host layers. LDH has advantages such as easily-adjustable compositions, easily-tailor structures, and easy combination with other materials to achieve functionalization. Thus, LDH has prominent applications in energy conversion and electrochemical energy storage such as supercapacitors, secondary cells, and electrocatalysis.

Generally, an ionic radius is a key factor determining whether a metal cation can enter a hydroxide layer. According to the Pauling's first rule, in this embodiment, since OH⁻ has an ionic radius of 133 pm and a coordination number of 3, a cation with an ionic radius of 55 pm to 98 pm should be stable in a metal hydroxide octahedron. According to the periodic table of elements, ionic radii of transition metals are suitable for the formation of LDH structures. Therefore, the transition metal cation in the first solution can include at least one of the following ions: Fe³⁺, Co²⁺, Cr³⁺, Cu²⁺, Zn²⁺, and Mn²⁺.

It should be noted that there can be one or more transition metal cations in the first solution. With Fe³⁺ and Co²⁺ as examples, Fe³⁺ can be provided by a corresponding metal salt (such as ferric nitrate nonahydrate), and Co²⁺ can be provided by a corresponding metal salt (cobalt nitrate hexahydrate). The nickel-based substrate material can be immersed in a Fe³⁺-containing solution to produce nickel-iron LDH, which is expressed as NiFe LDH/NF. The nickel-based substrate material can be immersed in a Co²⁺-containing solution to produce nickel-cobalt LDH, which is expressed as NiCo LDH/NF. The nickel-based substrate material can be immersed in a Fe³⁺ and Co²⁺-containing solution to produce nickel-iron-cobalt LDH, which is expressed as NiFeCo LDH/NF.

In some embodiments, the first solution can further include urea and ammonium fluoride. The high-temperature decomposition of urea leads to the production of ammonium and carbonate radicals, which can adjust a pH of the first solution. The ammonium radicals can also provide an alkaline environment for precipitating metal ions to produce hydroxides, such that the metal ions are evenly distributed on a substrate. The carbonate radicals can serve as intercalation anions. As a surface modifier, ammonium fluoride can adjust the growth orientation of a product and change the kinetic formation of crystal planes to form the unique lamellar morphology of LDH.

In some embodiments, the first solution can further include a surfactant. The surfactant can improve the reactivity in the modification treatment process, such that LDH with a uniform morphology and an appropriate introduced amount can be produced. For example, the surfactant can be one of sodium dodecyl sulfate (SDS), sodium dodecylbenzene sulfonate (SDBS), and cetyltrimethylammonium bromide (CTAB).

In the embodiment of the present disclosure, the first modification treatment process can be understood as a low-temperature wet chemical impregnation treatment, which is conducted at 30° C. to 60° C. for 4 h to 8 h. After the impregnation, a resulting nickel-based substrate material can be washed multiple times with deionized water and ethanol and then naturally dried, such that the corresponding LDH can be produced on the surface of the nickel-based substrate material, such as NiFe LDH/NF or NiCo LDH/NF.

Compared with the pure nickel-based substrate material, the surface modification of LDH can increase a specific surface area of the nickel-based substrate material, enhance the exposure of active sites of the nickel-based substrate material, and contribute to the full contact with an electrolyte and the rapid migration of charges during a heterogeneous catalysis process of water electrolysis.

S2: A plasma etching treatment is conducted for the LDH produced on the surface of the nickel-based substrate material after the first modification treatment to produce a cation/anion double vacancy-containing LDH.

In this step, the produced material is subjected to anion and cation removal by a plasma etching process, such that both anion and cation vacancy defects can be uniformly formed.

For example, a nickel-based substrate material obtained in the S1 can be flatly placed in a plasma etching instrument, then an Ar atmosphere is set, and the plasma etching treatment is conducted for 3 min to 30 min at a gas flow rate of 30 ccm to 70 ccm and an etching power of 50 W to 300 W. Ar atmosphere generates a large number of argon ions to interact with the LDH, so that the argon ions of their own energy transfer to the atoms of LDH, and then form a certain depth of the damage zone, that is, the formation of cation/anion double vacancies in the LDH material. After etching, many uniform cation/anion double vacancies are formed, and the metal cationic vacancies not only enhance the electrical conductivity of the material to accelerate the effective charge transfer, but also form new active sites to enhance the water electrolysis activity, in addition, the construction of cationic vacancies increases the surface area of the catalyst, so that the performance of electrocatalytic oxygen precipitation is greatly improved. Meanwhile, the large number of uniform cationic vacancies provided sufficient and stable anchoring sites for the immersion of high-valent metal cations.

After the etching of one side of the nickel-based substrate material is completed, the other side of the nickel-based substrate material can be treated in the same way to produce a nickel-iron LDH with cation/anion double vacancies at both sides, which is expressed as D_{O,Ni}-NiFe LDH/NF; or to produce a nickel-cobalt LDH with cation/anion double vacancies, which is expressed as D_{O,Ni}-NiCo LDH/NF. The double-sided etching promotes the generation of sufficient cation/anion vacancies, and further accelerates a water electrolysis reaction process.

If the etching time is too short or the etching power is too low during the plasma etching in the Ar atmosphere, enough vacancies will not appear. If the etching time is too long or the etching power is too high, there will be too many vacancies on a surface of the material, which may expand into large-scale defects and collapses to destroy the surface structure. Therefore, in this embodiment, exemplarily, the plasma etching treatment is controlled to be conducted for 3 min to 30 min at a gas flow rate of 30 ccm to 70 ccm and an etching power of 50 W to 300 W. S3: The cation/anion double vacancy-containing LDH produced after the plasma etching treatment is immersed in a second solution including a high-valent metal cation to allow a second modification treatment, such that a high-valent metal single atom-containing LDH is produced.

In this step, high-valent metal ions are introduced into cation vacancies by a low-temperature wet chemical method to construct a nickel-based electrode material with a high-valent metal system. The introduction of high-valent metal atoms can regulate a valence state of nickel atoms at active sites to optimize a binding energy of an OER intermediate on a surface of the catalytic material, reduce the overall OER energy barrier, and accelerate the kinetic process of water electrolysis, thereby allowing excellent electrocatalytic oxygen evolution performance.

Exemplarily, the high-valent metal cation in the second solution can include at least one of the following ionic salts: tungsten hexachloride, sodium molybdate dihydrate, and sodium metavanadate dihydrate.

In a specific example, the high-valent metal cation in the second solution can include W⁶⁺, and the second solution can be prepared from tungsten hexachloride, absolute ethanol, and pure water. A nickel-based substrate material obtained in the S2 is placed in a W⁶⁺-containing second solution to allow a reaction, then washed multiple times with deionized water and ethanol, and naturally dried, such that a nickel-iron LDH or a nickel-cobalt LDH including a high-valent single atom W can be produced on a surface of the nickel-based substrate material.

In another example, in order to make the high-valent metal cation in the second solution fully dissolved to maximize the modification, the high-valent metal cation in the second solution can include Mo⁶⁺, and the second solution can be prepared from sodium molybdate dihydrate and deionized water, and a temperature of the deionized water is 2° C. to 8° C. A nickel-based substrate material obtained in the S2 is placed in a Mo⁶⁺-containing second solution to allow a reaction, then washed with acetone, deionized water, and ethanol successively, and naturally dried, such that a nickel-iron LDH or a nickel-cobalt LDH including a high-valent single atom Mo can be produced on a surface of the nickel-based substrate material.

In another specific example, the high-valent metal cation in the second solution can include V⁵⁺, and the second solution can be prepared from sodium metavanadate dihydrate and pure water. A water bath for the second modification treatment has a temperature of 50° C. to 70° C. A nickel-based substrate material obtained in the S2 is placed in a V⁵⁺-containing second solution to allow a reaction, then washed with acetone, deionized water, and ethanol successively, and naturally dried, such that a nickel-iron LDH or a nickel-cobalt LDH including a high-valent single atom V can be produced on a surface of the nickel-based substrate material.

It should be noted that there can also be two or more high-valent metal cations in the second solution. Correspondingly, a product obtained after the reaction in the S3 can be understood as a nickel-iron LDH or a nickel-cobalt LDH including a high-valent single atom X, which is expressed as D_{O}-NiFe—X LDH/NF or D_{O}-NiCo—X LDH/NF, where X represents two or more high-valent metal elements.

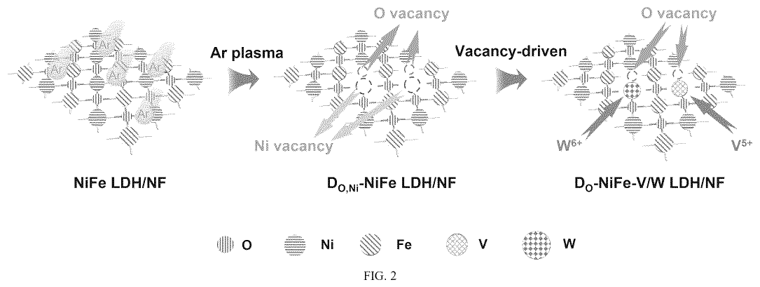

An experimental design principle of the surface modification method of a nickel-based catalytic material for water electrolysis provided in the embodiment of the present disclosure is shown in FIG. 2. NiFe LDH is first modified on a surface of a nickel-based substrate material through low-temperature wet chemical impregnation. Then, a NiFe LDH/NF composite catalytic material is modified through plasma etching in an Ar atmosphere to form uniform vacancies of nickel and oxygen atoms. Finally, with the assistance of hydrothermal synthesis, a D_{O}-NiCo—V/W LDH/NF nickel-based electrode material with a high-valent element single-atom system is constructed. The reasonable introduction of the high-valent element makes an electron cloud on nickel active sites in the material biased towards high-valent atoms, such that nickel atoms are close to a valency of 3+ and an active phase NiOOH is reached in advance during a water electrolysis-based OER process. Moreover, the high-valent element not only promotes the reconstitution of a threshold, but also increases the strength of a reconstituted active phase, thereby greatly improving the performance of electrocatalytic oxygen evolution.

As described above, the surface modification method of a nickel-based catalytic material for water electrolysis in the embodiment of the present disclosure is as follows: A nickel-based substrate material to be modified is first immersed in a first solution including a transition metal cation to allow a first modification treatment, such that an LDH is produced on a surface of the nickel-based substrate material. Then plasma etching treatment is conducted for the LDH produced on the surface of the nickel-based substrate material after the first modification treatment to produce a cation/anion double vacancy-containing LDH. The cation/anion double vacancy-containing LDH produced after the plasma etching treatment is then immersed in a second solution including a high-valent metal cation to allow a second modification treatment, such that a high-valent metal single atom-containing LDH is produced.

That is, in the embodiment of the present disclosure, a nickel-based composite catalytic material with uniform vacancies of nickel and oxygen atoms can be first prepared controllably through wet chemical impregnation and plasma etching, and then a nickel-based electrode material with a high-valent element single-atom system can be further constructed with the assistance of hydrothermal synthesis. This preparation method involves a simple process and easily-available raw materials. In addition, the nickel-based electrode material with a high-valent element single-atom system allows a rapid, efficient, and mild reaction and high electrocatalytic oxygen evolution performance, is suitable for large-area production, and has a great potential value and a promising application prospect in water electrolysis. Therefore, the present disclosure provides a research idea for the preparation of electrode materials for efficient and stable alkaline electrolytic cells.

In addition, an embodiment of the present disclosure provides a catalytic material for water electrolysis. The catalytic material for water electrolysis includes a nickel-based substrate material and a high-valent metal single atom-containing LDH modified on a surface of the nickel-based substrate material, where the catalytic material for water electrolysis is prepared by the surface modification method of a nickel-based catalytic material for water electrolysis described above.

To facilitate those skilled in the art to clearly understand the surface modification method of a nickel-based catalytic material for water electrolysis in the embodiment of the present disclosure and the performance advantages of the surface modification method, the present disclosure is described below with specific examples.

### Example 1

In Example 1, a pure nickel foam was adopted as a nickel-based catalytic material for water electrolysis, a nickel-iron LDH (NiFe LDH/NF) was produced after a first modification treatment, and a high-valent metal element introduced after a second modification treatment was tungsten. A surface modification method based on the pure nickel foam substrate included the following steps:

(1) A 11 cm×11 cm nickel foam was ultrasonically treated for 15 min in 6 M hydrochloric acid, acetone, ethanol, and deionized water successively, and then dried in a drying oven at a constant temperature of 50° C. to produce a pretreated nickel catalytic material.

(2) At room temperature, 8.059 g of ferric nitrate nonahydrate, 1.736 g of SDBS, 6.4 g of urea, and 4.4 g of ammonium fluoride were added to 2,000 mL of pure water to produce a compound solution A.

(3) The pretreated nickel catalytic material obtained in the step (1) was added to the compound solution A, and a wet chemical impregnation treatment was conducted at 40° C. for 6 h. A resulting composite material was washed multiple times with deionized water and ethanol, and then naturally dried to produce a nickel-iron LDH. A resulting composite material was expressed as NiFe LDH/NF, indicating that the composite material was prepared based on a ferric nitrate nonahydrate precursor solution.

(4) At room temperature, the NiFe LDH/NF nickel-based catalytic material obtained in the step (3) was flatly placed in a plasma etching instrument. An Ar atmosphere was set, a flow rate was set to 50 ccm, and a power was set to 150 W. One side of the material was subjected to etching for 10 min. Then the other side of the material was treated in the same way to produce a cation/anion double vacancy-containing nickel-iron LDH. A resulting composite material was expressed as D_{O,Ni}-NiFe LDH/NF, indicating that the composite material was prepared based on the Ar atmosphere.

(5) At room temperature, 0.0119 g of tungsten hexachloride was dissolved in a mixed liquid of 150 mL of absolute ethanol and 150 mL of pure water to produce a solution B.

(6) In a water bath at 60° C., the D_{O,Ni}-NiFe LDH/NF nickel-based catalytic material obtained in the step (4) was placed in the solution B for 30 min, and then sealed to allow a complete reaction. A resulting composite material was washed multiple times with deionized water and ethanol, and then naturally dried to produce a high-valent single-atom tungsten-containing nickel-iron LDH. A resulting composite material was expressed as D_{O}-NiFe—W LDH/NF, indicating that the composite material was prepared based on a tungsten hexachloride precursor solution.

### Example 2

In Example 2, a nickel mesh was adopted as a nickel-based catalytic material for water electrolysis, a nickel-iron LDH (NiFe LDH/NF) was produced after a first modification treatment, and a high-valent metal element introduced after a second modification treatment was molybdenum. A surface modification method based on the nickel mesh substrate included the following steps:

(1) A 11 cm×11 cm nickel mesh was ultrasonically treated for 15 min in 6 M hydrochloric acid, acetone, ethanol, and deionized water successively, and then dried in a drying oven at a constant temperature of 50° C. to produce a pretreated nickel catalytic material.

(2) At room temperature, 8.059 g of ferric nitrate nonahydrate, 1.736 g of SDBS, 6.4 g of urea, and 4.4 g of ammonium fluoride were added to 2,000 mL of pure water to produce a compound solution A.

(3) The pretreated nickel catalytic material obtained in the step (1) was added to the compound solution A, and a wet chemical impregnation treatment was conducted at 40° C. for 6 h. A resulting composite material was washed multiple times with deionized water and ethanol, and then naturally dried to produce a nickel-iron LDH. A resulting composite material was expressed as NiFe LDH/NF, indicating that the composite material was prepared based on a ferric nitrate nonahydrate precursor solution.

(4) At room temperature, the NiFe LDH/NF nickel-based catalytic material obtained in the step (3) was flatly placed in a plasma etching instrument. An Ar atmosphere was set, a flow rate was set to 50 ccm, and a power was set to 100 W. One side of the material was subjected to etching for 20 min. Then the other side of the material was treated in the same way to produce a cation/anion double vacancy-containing nickel-iron LDH. A resulting composite material was expressed as D_{O,Ni}-NiFe LDH/NF, indicating that the composite material was prepared based on the Ar atmosphere.

(5) At 2° C. to 8° C., 0.1765 g of sodium molybdate dihydrate was dissolved in 300 mL of low-temperature deionized water to produce a solution B.

(6) The D_{O,Ni}-NiFe LDH/NF nickel-based catalytic material obtained in the step (4) was placed in the solution B for 30 min to allow a complete reaction, washed with acetone, deionized water, and ethanol successively, and then naturally dried to produce a high-valent single-atom Mo-containing nickel-iron LDH. A resulting composite material was expressed as D_{O}-NiFe—Mo LDH/NF, indicating that the composite material was prepared based on a sodium molybdate dihydrate precursor solution.

### Example 3

In Example 3, a nickel foam was adopted as a nickel-based catalytic material for water electrolysis, a nickel-iron LDH (NiFe LDH/NF) was produced after a first modification treatment, and high-valent metal elements introduced after a second modification treatment were vanadium and tungsten. A surface modification method based on the nickel foam substrate included the following steps:

(1) A 11 cm×11 cm nickel foam was ultrasonically treated for 15 min in 6 M hydrochloric acid, acetone, ethanol, and deionized water successively, and then dried in a drying oven at a constant temperature of 50° C. to produce a pretreated nickel catalytic material.

(2) At room temperature, 8.059 g of ferric nitrate nonahydrate, 1.736 g of SDBS, 6.4 g of urea, and 4.4 g of ammonium fluoride were added to 2,000 mL of pure water to produce a compound solution A.

(3) The pretreated nickel catalytic material obtained in the step (1) was added to the compound solution A, and a wet chemical impregnation treatment was conducted at 40° C. for 6 h. A resulting composite material was washed multiple times with deionized water and ethanol, and then naturally dried to produce a nickel-iron LDH. A resulting composite material was expressed as NiFe LDH/NF, indicating that the composite material was prepared based on a ferric nitrate nonahydrate precursor solution.

(4) At room temperature, the NiFe LDH/NF nickel-based catalytic material obtained in the step (3) was flatly placed in a plasma etching instrument. An Ar atmosphere was set, a flow rate was set to 50 ccm, and a power was set to 200 W. One side of the material was subjected to etching for 5 min. Then the other side of the material was treated in the same way to produce a cation/anion double vacancy-containing nickel-iron LDH. A resulting composite material was expressed as D_{O,Ni}-NiFe LDH/NF, indicating that the composite material was prepared based on the Ar atmosphere.

(5) At room temperature, 0.005 g of sodium metavanadate dihydrate and 0.0119 g of tungsten hexachloride were dissolved in a mixed liquid of 150 mL of absolute ethanol and 150 mL of pure water to produce a solution B.

(6) In a water bath at 60° C., the D_{O,Ni}-NiFe LDH/NF nickel-based catalytic material obtained in the step (4) was placed in the solution B for 30 min, and then sealed to allow a complete reaction. A resulting composite material was washed with acetone, deionized water, and ethanol successively, and then naturally dried to produce a high-valent single-atom vanadium/tungsten-containing nickel-iron LDH. A resulting composite material was expressed as D_{O}-NiFe—V/W LDH/NF, indicating that the composite material was prepared based on a sodium metavanadate dihydrate/tungsten hexachloride precursor solution.

### Example 4

In Example 4, a nickel foam was adopted as a nickel-based catalytic material for water electrolysis, a nickel-cobalt LDH (NiCo LDH/NF) was produced after a first modification treatment, and high-valent metal elements introduced after a second modification treatment were vanadium and tungsten. A surface modification method based on the nickel foam substrate included the following steps:

(1) A 11 cm×11 cm nickel mesh was ultrasonically treated for 15 min in 6 M hydrochloric acid, acetone, ethanol, and deionized water successively, and then dried in a drying oven at a constant temperature of 50° C. to produce a pretreated nickel catalytic material.

(2) At room temperature, 5.805 g of cobalt nitrate hexahydrate, 1.736 g of SDBS, 6.4 g of urea, and 4.4 g of ammonium fluoride were added to 2,000 mL of pure water to produce a compound solution A.

(3) The pretreated nickel catalytic material obtained in the step (1) was added to the compound solution A, and a wet chemical impregnation treatment was conducted at 40° C. for 6 h. A resulting composite material was washed multiple times with deionized water and ethanol, and then naturally dried to produce a nickel-cobalt LDH. A resulting composite material was expressed as NiCo LDH/NF, indicating that the composite material was prepared based on a cobalt nitrate hexahydrate precursor solution.

(4) At room temperature, the NiCo LDH/NF nickel-based catalytic material obtained in the step (3) was flatly placed in a plasma etching instrument. An Ar atmosphere was set, a flow rate was set to 50 ccm, and a power was set to 100 W. One side of the material was subjected to etching for 20 min. Then the other side of the material was treated in the same way to produce a cation/anion double vacancy-containing nickel-cobalt LDH. A resulting composite material was expressed as D_{O,Ni}-NiCo LDH/NF, indicating that the composite material was prepared based on the Ar atmosphere.

(5) At room temperature, 0.005 g of sodium metavanadate dihydrate and 0.0119 g of tungsten hexachloride were dissolved in a mixed liquid of 150 mL of absolute ethanol and 150 mL of pure water to produce a solution B.

(6) In a water bath at 60° C., the D_{O,Ni}-NiCo LDH/NF nickel-based catalytic material obtained in the step (4) was placed in the solution B for 30 min, and then sealed to allow a complete reaction. A resulting composite material was washed with acetone, deionized water, and ethanol successively, and then naturally dried to produce a high-valent single-atom vanadium/tungsten-containing nickel-cobalt LDH. A resulting composite material was expressed as D_{O}-NiCo—V/W LDH/NF, indicating that the composite material was prepared based on a sodium metavanadate dihydrate/tungsten hexachloride precursor solution.

D_{O}-NiFe—W LDH/NF, D_{O}-NiFe—Mo LDH/NF, D_{O}-NiFe—V/W LDH/NF, and D_{O}-NiCo—V/W LDH/NF prepared in Examples 1 to 4 were analyzed for performance below. As a contrast, the embodiments of the present disclosure also provided the experimental data of a 0.3 Nm³ industrial electrolytic cell of commercial Raney-Ni.

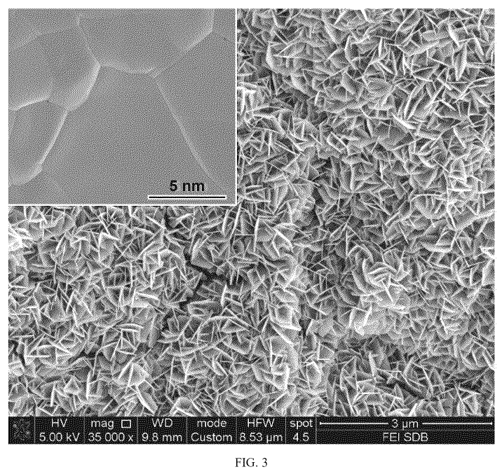

FIG. 3 shows scanning electron microscopy images of the pure NF and NiFe LDH/NF catalytic materials provided in the embodiment of the present disclosure, where the scanning electron microscope image of pure NF is shown in the upper left corner of FIG. 3. It can be seen that, before modification, the pure NF has a smooth surface, a small roughness, and a small specific surface area. Thus, the pure NF includes few active sites involved in the reaction and leads to poor oxygen evolution performance of water electrolysis. After modification, an LDH structure is formed on a surface of the nickel-based substrate material, which increases a corresponding specific surface area, enhances the exposure of active sites, and contributes to the full contact with an electrolyte and the rapid migration of charges during a heterogeneous catalysis process of water electrolysis.

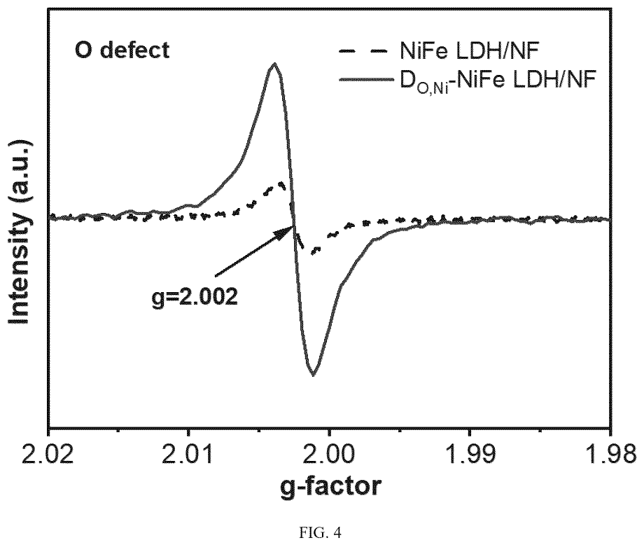

FIG. 4 shows EPR spectroscopy spectra of oxygen vacancies in the D_{O,Ni}-NiFe LDH/NF and NiFe LDH/NF catalytic materials provided in the embodiment of the present disclosure. As shown in FIG. 4, both D_{O,Ni}-NiFe LDH/NF and NiFe LDH/NF have a Lorenz curve with a g value of 2.002, indicating that oxygen vacancies in a nano-scale LDH structure of the NiFe LDH catalytic material lead to the generation of unpaired electrons. Moreover, after the plasma etching in the Ar atmosphere, oxygen vacancies in the D_{O,Ni}-NiFe LDH/NF catalytic material show a strong EPR signal, indicating that there is a high concentration of unpaired electrons of oxygen.

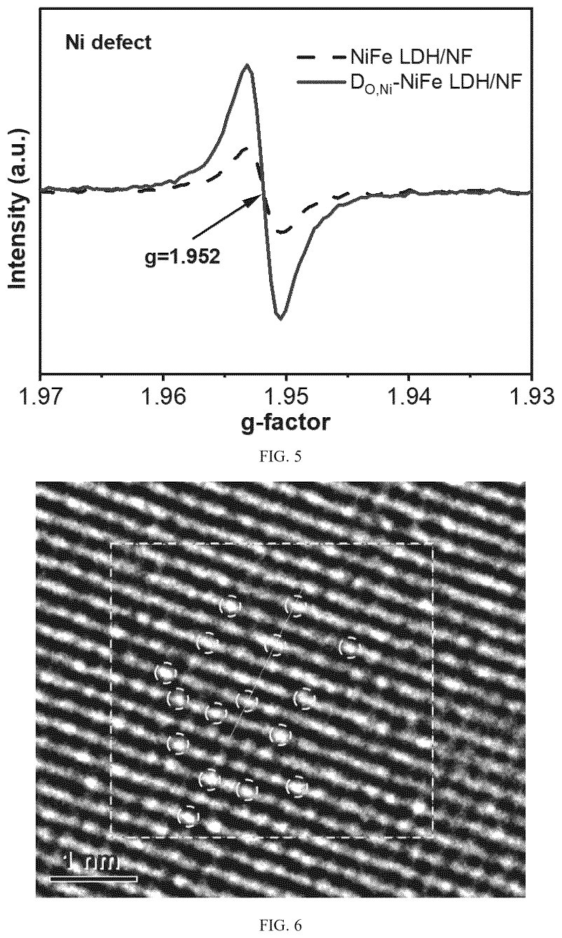

FIG. 5 shows EPR spectroscopy spectra of nickel vacancies in the D_{O,Ni}-NiFe LDH/NF and NiFe LDH/NF catalytic materials provided in the embodiment of the present disclosure. As shown in FIG. 5, both D_{O,Ni}-NiFe LDH/NF and NiFe LDH/NF have a Lorenz curve with a g value of 1.952, indicating that nickel atom vacancies are formed in a nano-scale LDH structure of the NiFe LDH catalytic material in the preparation process. Moreover, after the plasma etching in the Ar atmosphere, the D_{O,Ni}-NiFe LDH/NF catalytic material has an increased number of nickel vacancies, which allows the high randomness and uniformity of sites for introducing high-valent single atoms.

FIG. 6 shows a transmission electron microscopy image of the D_{O}-NiFe—V/W LDH/NF catalytic material provided in the embodiment of the present disclosure. It can be seen from FIG. 6 that the D_{O}-NiFe—V/W LDH/NF catalytic material has bright light spots. In short, the brightness of a heavy atom element in a same crystal plane is proportional to a square of an atomic number in a sensitive dark field image under a black background. That is, the larger the atomic number of a sample, the brighter the light spot, and the smaller the atomic number of a sample, the darker the light spot. Thus, it can be known that vanadium and tungsten atoms are uniformly present (which are represented by dotted circles in this figure). The introduction of the double single atoms can regulate a valence state of nickel atoms at active sites to optimize a binding energy of an OER intermediate on a surface of the catalytic material, reduce the overall OER energy barrier, and accelerate the kinetic process of water electrolysis, thereby allowing excellent electrocatalytic oxygen evolution performance.

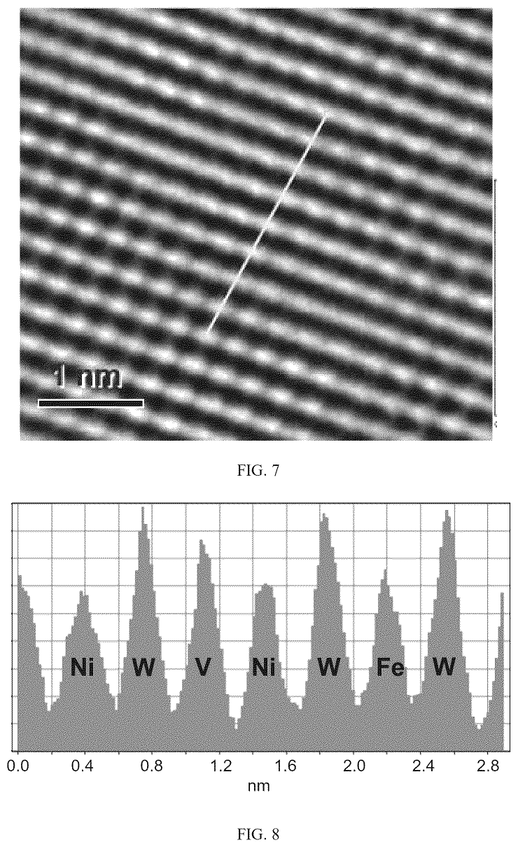

FIG. 7 and FIG. 8 show a partial magnification and an atomic integral intensity map of a transmission electron microscope of a D_{O}-NiFe—V/W LDH/NF catalytic material provided by embodiments of the present disclosure. Generally speaking, elements with high atomic numbers will scatter incident electrons more strongly because they have more electrons outside the nucleus, and thus exhibit higher peaks in the atomic integral intensity map of the transmission electron microscope, and in combination with FIG. 6, it can be seen that the peaks with the same heights are of the same kind of elements, which are tungsten, vanadium, iron, and nickel, respectively.

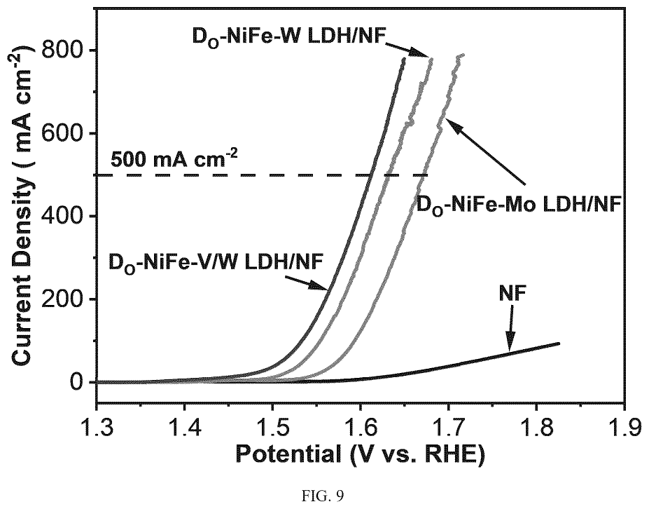

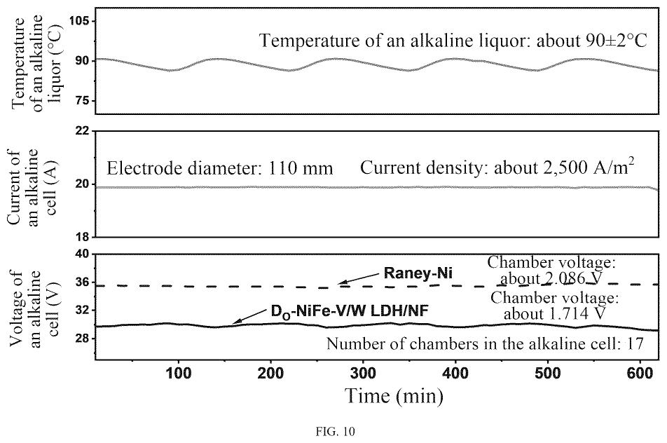

FIG. 9 shows performance testing results of electrolytic cells with NF, D_{O}-NiFe—W LDH/NF, D_{O}-NiCo—Mo LDH/NF, and D_{O}-NiFe—V/W LDH/NF nickel-based catalytic composite materials provided in the embodiment of the present disclosure.

Table 1 shows performance testing data of electrolytic cells with the pure nickel foam catalytic material NF and the D_{O}-NiFe—W LDH/NF, D_{O}-NiCo—Mo LDH/NF, and D_{O}-NiFe—V/W LDH/NF nickel-based catalytic composite materials corresponding to FIG. 9.

TABLE 1

| | Over- | Over- | Over- |
|---|---|---|---|
| | potential | potential | potential |
| | η at 10 mA | η at 250 mA | η at 500 mA |
| | cm⁻² (mV) | cm⁻² (mV) | cm⁻² (mV) |
| NF | 422 | 529 | 738 |
| D_{O} —NiFe—W LDH/NF | 266 | 359 | 401 |
| D_{O} —NiCo—Mo LDH/NF | 303 | 398 | 442 |
| D_{O} —NiFe—V/W LDH/NF | 205 | 340 | 377 |

It can be seen from FIG. 9 and Table 1 that, under testing conditions of a three-electrode system, the nickel-based catalytic material doped with a high-valent single atom (D_{O}-NiFe—W LDH/NF) and the nickel-based catalytic material doped with double high-valent single atoms (D_{O}-NiFe—V/W LDH/NF) both exhibit higher electrocatalytic oxygen evolution activities than the pure nickel foam catalytic material NF and the catalytic material with a nano-scale layered structure (NiFe LDH/NF). Overpotentials of the nickel-based catalytic material doped with a high-valent single atom (D_{O}-NiFe—W LDH/NF) and the nickel-based catalytic material doped with double high-valent single atoms (D_{O}-NiFe—V/W LDH/NF) at current densities of 10 mA/cm² and 250 mA/cm² reach 266 m V and 359 mV, and 205 mV and 340 mV, respectively, which are significantly lower than overpotentials of the pure nickel foam catalytic material NF without modification at current densities of 10 mA/cm² and 250 mA/cm².

In addition, an overpotential of the nickel-based catalytic material doped with double high-valent single atoms (D_{O}-NiFe—V/W LDH/NF) is merely 377 mV at a high current density of 500 mA/cm², which is significantly lower than an overpotential of the pure nickel foam catalytic material NF without modification at a high current density of 500 mA/cm² and is very suitable for the long-term use under industrial-grade high current conditions.

As mentioned above, in the embodiment of the present disclosure, the NiFe LDH/NF composite catalytic material is modified through plasma etching in an Ar atmosphere to form uniform vacancies of nickel and oxygen atoms. These vacancies can further accelerate the evolution of active sites in the catalytic material during a water electrolysis-based OER process, optimize a binding energy of a water electrolysis-based OER intermediate on a surface of the catalytic material, further reduce the energy barrier, and accelerate the kinetic process of water electrolysis, thereby allowing excellent electrocatalytic oxygen evolution performance.

As the most common water electrolysis electrode, the commercial Raney-Ni exhibits a prominent catalytic activity due to a large specific surface area formed during a reaction. However, in addition to a high cost and process complexity of a preparation process, the commercial Raney-Ni electrode exhibits weak reverse current resistance when in service, and catalytic components of the electrode are easily dissolved under long-term power failure to reduce the activity of the electrode, which leads to poor stability of the catalytic material. Due to the long-term material activity and stability problems, industrial water electrolytic cell manufacturers need to frequently change and maintain electrode materials at two electrodes in an electrolytic cell, which increases the maintenance cost and thus has always been called the “industry pain point” in the electrolytic cell industry.

FIG. 10 shows testing results of a commercial 0.3 Nm³ industrial alkaline electrolytic cell with the D_{O}-NiFe—W LDH/NF catalytic material provided in the embodiment of the present disclosure.

Under the following electrolytic cell operating conditions: (national standard: T/CAB 0166-2022) direct current density: 2,500 A/m²±100 A/m², a temperature of a hydrogen production system was a working temperature: 90° C.±2° C., and a working pressure: 1.1 MPa, an average chamber voltage and an energy consumption per unit of direct current W_{d} of an electrolytic cell were calculated according to GB 32311-2015. The energy consumption per unit of direct current was tested more than 6 times at an interval of 10 min, and an average was taken. During each test, a value was read after a state was stabilized for 10 min.

A calculation formula for a direct-current energy consumption was as follows:

$${W}_{d} = 2390 E / 1000$$

where W_{d} represents a direct-current energy consumption value, in a unit of kWh/m³ H₂; 2390 represents a theoretical electric quantity required to produce 1 Nm³ of hydrogen by an electrolytic cell under a standard state; and 1000 represents a conversion factor.

Based on 17 chambers of an electrolytic cell, average direct-current voltages of the commercial Raney-Ni electrode^{(+,-)} and D_{O}-NiFe—V/W LDH/NF^{(+,-)} catalytic electrode materials are 2.089 V and 1.714 V, respectively, where (+,−) means that positive and negative electrodes in the electrolytic cell are a same catalytic material. Direct-current energy consumption values calculated for the above materials according to the above formula are 5.0 kWh/m³ H₂ and 4.1 kWh/m³ H₂, respectively. It indicates that a NiFe LDH/NF composite catalytic material is modified through plasma etching in an Ar atmosphere to form uniform vacancies of nickel and oxygen atoms, and then with the assistance of hydrothermal synthesis, a nickel-based electrode material with a high-valent element single-atom system is constructed.

The embodiments of the present disclosure controllably prepared nickel-based composite catalytic materials containing uniform vacancies of nickel and oxygen atoms by treating NiFe LDH/NF to plasma etching in an Ar atmosphere, and then constructed nickel-based electrode materials of high-valent elemental single-atom system with the assistance of hydrothermal method. The process is simple, the raw materials are easily available, the reaction is mild, fast and efficient, suitable for large-scale production, and it has great potential value in water electrolysis as well as application prospects, which provides research ideas for constructing efficient and stable electrode materials for alkaline electrolytic cells.

The detailed description for the embodiments may refer to the corresponding description in the preceding embodiments, and will not be repeated herein.

The basic principles of the present disclosure are described above in conjunction with specific embodiments. However, it should be pointed out that the advantages, properties, effects, etc. mentioned in the present disclosure are only exemplary and restrictive. It cannot be considered that these advantages, properties, effects, etc. are necessary for each embodiment of the present disclosure. In addition, the specific details disclosed above are only for illustration and easy comprehension, rather than for limitation, and the above details do not mean that the present disclosure must be achieved with the above specific details.

In the present disclosure, relational terms such as first and second are merely used to distinguish one entity or operation from another entity or operation without necessarily requiring or implying any actual such relationship or order between the entities or operations.

In addition, as used here, the use of “or” in the enumeration of items beginning with “at least one” indicates the separate enumeration, such that, for example, the enumeration of “at least one of A, B, or C” indicates A or B or C, or AB or AC or BC, or ABC (namely, A and B and C). In addition, the expression “exemplary” does not imply that a described example is preferred or better than other examples.

It should also be noted that, in the system and method of the present disclosure, individual components or steps can be split and/or recombined. The splitting and/or recombination shall be considered as equivalent solutions for the present disclosure.

Various alterations, substitutions, and changes may be made to the technologies described here without departing from the taught technologies defined by the appended claims. In addition, the scope of the claims of the present disclosure is not limited to the specific aspects of compositions, means, methods, and actions of the treatments, machines, manufactures, and events described above. Compositions, means, methods, or actions of treatments, machines, manufactures, and events, which currently exist or are to be developed later, may be utilized to perform substantially the same functions or to achieve substantially the same results as those described herein. Thus, the appended claims include the compositions, means, methods, or actions of such treatments, machines, manufactures, and events within the scope.

The above description of the aspects of the present disclosure is provided to allow any person skilled in the art to implement or utilize the present disclosure. Various modifications to these aspects are readily apparent to those skilled in the art, and the general principles defined here can be applied to other aspects without departing from the scope of the present disclosure. Accordingly, the present disclosure is not intended to be limited to the aspects illustrated herein, rather to follow the broadest scope consistent with the principles and novel features disclosed herein.

The above description has been given for illustration and explanation. In addition, this description is not intended to limit the embodiments of the present disclosure to the form disclosed herein. Although a number of example aspects and embodiments have been discussed above, those skilled in the art will recognize some variations, modifications, changes, additions, and sub-combinations thereof.

What is claimed is:

1. A surface modification method of a nickel-based catalytic material for a water electrolysis, comprising:
immersing a nickel-based substrate material to be modified in a first solution comprising a transition metal cation to allow a first modification treatment, such that a layered double hydroxide (LDH) is produced on a surface of the nickel-based substrate material;
conducting a plasma etching treatment for the LDH produced on the surface of the nickel-based substrate material after the first modification treatment to produce a cation/anion double vacancy-containing LDH; and
immersing the cation/anion double vacancy-containing LDH produced after the plasma etching treatment in a second solution comprising a high-valent metal cation to allow a second modification treatment, such that a high-valent metal single atom-containing LDH is produced.

2. The surface modification method according to claim 1, wherein the transition metal cation in the first solution comprises at least one of the following ions: a Fe ion, a Co ion, a Cr ion, a Cu ion, a Zn ion, and a Mn ion.

3. The surface modification method according to claim 1, wherein the first solution further comprises urea and ammonium fluoride.

4. The surface modification method according to claim 1, wherein the first solution further comprises a surfactant.

5. The surface modification method according to claim 1, wherein the first modification treatment is conducted for 4 h to 8 h at 30° C. to 60° C.

6. The surface modification method according to claim 1, wherein the high-valent metal cation in the second solution comprises at least one of the following ionic salts: tungsten hexachloride, sodium molybdate dihydrate, and sodium metavanadate dihydrate.

7. The surface modification method according to claim 1, wherein the high-valent metal cation in the second solution comprises a tungsten ion, and the second solution is prepared from tungsten hexachloride, absolute ethanol, and pure water.

8. The surface modification method according to claim 1, wherein the high-valent metal cation in the second solution comprises a molybdenum ion, the second solution is prepared from sodium molybdate dihydrate and deionized water, and a temperature of the deionized water is 2° C. to 8° C.

9. The surface modification method according to claim 1, wherein the high-valent metal cation in the second solution comprises a vanadium ion, and the second solution is prepared from sodium metavanadate dihydrate and pure water; and a water bath for the second modification treatment has a temperature of 50° C. to 70° C.

10. A catalytic material for a water electrolysis, comprising the nickel-based substrate material and the high-valent metal single atom-containing LDH modified on the surface of the nickel-based substrate material, wherein the catalytic material for the water electrolysis is prepared by the surface modification method of the nickel-based catalytic material for the water electrolysis according to claim 1.

11. The catalytic material according to claim 10, wherein in the surface modification method, the transition metal cation in the first solution comprises at least one of the following ions: a Fe ion, a Co ion, a Cr ion, a Cu ion, a Zn ion, and a Mn ion.

12. The catalytic material according to claim 10, wherein in the surface modification method, the first solution further comprises urea and ammonium fluoride.

13. The catalytic material according to claim 10, wherein in the surface modification method, the first solution further comprises a surfactant.

14. The catalytic material according to claim 10, wherein in the surface modification method, the first modification treatment is conducted for 4 h to 8 h at 30° C. to 60° C.

15. The catalytic material according to claim 10, wherein in the surface modification method, the high-valent metal cation in the second solution comprises at least one of the following ionic salts: tungsten hexachloride, sodium molybdate dihydrate, and sodium metavanadate dihydrate.

16. The catalytic material according to claim 10, wherein in the surface modification method, the high-valent metal cation in the second solution comprises a tungsten ion, and the second solution is prepared from tungsten hexachloride, absolute ethanol, and pure water.

17. The catalytic material according to claim 10, wherein in the surface modification method, the high-valent metal cation in the second solution comprises a molybdenum ion, the second solution is prepared from sodium molybdate dihydrate and deionized water, and a temperature of the deionized water is 2° C. to 8° C.

18. The catalytic material according to claim 10, wherein in the surface modification method, the high-valent metal cation in the second solution comprises a vanadium ion, and the second solution is prepared from sodium metavanadate dihydrate and pure water; and a water bath for the second modification treatment has a temperature of 50° C. to 70° C.
